(19) United States
(12) Patent Application Publication
(10) Pub. No.: US 2026/0219118 A1
(43) Pub. Date: Jul. 30, 2026

(54) FORCE DETECTING COLLAR

(71) Applicant: Crown Packaging Technology, Inc., Tinley Park, IL (US)

(72) Inventors: Christopher HARTE, Wantage, Oxfordshire (GB); Mark DAVIES, Wantage, Oxfordshire (GB)

(73) Assignee: Crown Packaging Technology, Inc., Tinley Park, IL (US)

(21) Appl. No.: 19/141,936

(22) PCT Filed: Dec. 15, 2023
(86) PCT No.: PCT/GB2023/053265

§ 371 Date: Jun. 20, 2025

(30) Foreign Application Priority Data
Dec. 21, 2022 (GB) 2219337.9

(51) Int. Cl. G01L 5/00; B21D 22/28; B21D 51/26; B30B 15/00

(52) U.S. Cl. CPC G01L 5/0076; B21D 22/28; B21D 51/26; B30B 15/0094

(57) ABSTRACT

A force detecting collar for use with a bodymaker for forming metal can bodies using an ironing process. The collar is configured to locate around a nose portion of a ram of the bodymaker, between a circumferentially extending shoulder of the ram and an end face of a punch sleeve, the collar comprising one or more load cells fixed to the collar and configured to generate electrical signals indicative of forces applied to the collar, between said shoulder of the ram and said end face of the punch sleeve, during operation of the ram.

### TECHNICAL FIELD

The invention relates to a force detecting collar for use with a can bodymaker.

### BACKGROUND

In known can bodymakers for the production of can bodies by a drawing and ironing process, a pre-formed metal cup is fed to the bodymaker and carried by a punch on the end of a ram through a series of dies to produce a can body of the desired size and thickness. The series of dies may include a redraw die for reducing the diameter of the cup and lengthening its sidewall, and one or more ironing dies for wall-ironing the cup into a can body. The area or cradle of the bodymaker frame within which the dies are located is known as the “toolpack”. The can body carried on the punch may ultimately contact a bottom forming tool or “domer” so as to form a shape such as a dome on the base of the can.

Can bodymakers are typically operated for extended periods at high speed to produce more than around 300 to 400 can bodies per minute. However, the quality of the can bodies that are produced can vary significantly over time because of changes in, for example, the alignment of the machine components, coolant temperature and flow rate, lubrication of the machine, and/or the quality of the incoming cups (e.g. because of variations in the quality of the metal coil from which the cups are made). Furthermore, one or more components of can bodymakers, in particular the punch, need to be replaced over time as a result of general wear during operation of the bodymaker. If such components are not replaced at the right time, can body quality may deteriorate to an unacceptable extent, and the components may even fail catastrophically causing significant losses in production time, or else may be replaced prematurely, leading to wastage. The high speed, high volume nature of the can production industry means that lost production time can be very costly for producers.

### SUMMARY

According to a first aspect of the present invention there is provided a force detecting collar for use with a bodymaker for forming metal can bodies using an ironing process. The collar is configured to locate around a nose portion of a ram of the bodymaker, between a circumferentially extending shoulder of the ram and an end face of a punch sleeve, the collar comprising one or more load cells fixed to the collar and configured to generate electrical signals indicative of forces applied to the collar, between said shoulder of the ram and said end face of the punch sleeve, during operation of the ram.

The one or more load cells may be fixed to an inner surface of the collar. The force detecting collar may comprise first and second circumferentially extending end shoulders defining therebetween an inner circumferentially extending recess on an inner surface of the collar, the one or more load cells being fixed within the recess. The inner circumferentially extending recess may extend completely around the inner surface. The force detecting collar may further comprise a plurality of said load cells, the plurality of load cells being substantially equally spaced about the inner circumferentially extending recess. The circumferentially extending end shoulders of the collar may further define therebetween an outer circumferentially extending recess on an outer surface of the collar.

The collar may define a channel extending between an inner surface and an outer surface of the collar and accommodating one or more wires coupled to the one or more load cells for communicating, in use, the generated electrical signals from the one or more load cells to external equipment. The channel may be defined by a bore extending through the collar or by a clamping plate secured to an inner surface of the collar, the clamping plate configured to inhibit movement of said one or more wires relative to the one or more load cells.

The length of the collar may be substantially 25 mm to substantially 50 mm. The ratio of an axial length of the one or more load cells to a length of the collar may be substantially 0.72.

According to a second aspect of the present invention there is provided an assembly for use with a bodymaker for forming metal can bodies using an ironing process. The assembly comprises a ram comprising a ram body and a nose portion and defining a circumferentially extending shoulder between the ram body and the nose portion, a punch sleeve comprising an end face and being located coaxially around the nose portion such that said end face is opposed to said shoulder. The assembly further comprises a collar according to the above first aspect, the collar being located around the nose portion of the ram, between the circumferentially extending shoulder of the ram and the end face of the punch sleeve. The assembly is configured such that forces applied to the punch sleeve axially towards said shoulder of the ram are transferred to said collar.

The assembly may comprise a punch nose fixed to a front end of the nose portion of the ram and at least partially received within the punch sleeve, the assembly being configured such that forces applied to the punch nose axially towards said shoulder of the ram are transferred to the nose portion of the ram and not to the punch sleeve.

The ram may comprise an inner surface defining an inner chamber, the ram further defining a channel extending between the inner chamber and an outer surface of the ram, the channel accommodating the one or more wires such that the one or more wires are received within the inner chamber. Opposed openings of the channels may be aligned with one another.

The assembly may comprise a radio transmitter (or other wireless transmitter) located within the inner chamber, the transmitter coupled to the one or more wires for receiving said generated electrical signals and retransmitting them over a radio or other wireless interface.

According to a third aspect of the present invention there is provided a can bodymaker for forming metal can bodies using an ironing process and comprising an assembly according to the above second aspect.

### BRIEF DESCRIPTION OF THE DRAWINGS

FIG. 1a shows an axial section view of an exemplary force detecting collar for use with a can bodymaker;

FIG. 1b shows a top plan view of the exemplary collar of FIG. 1a;

FIG. 2 shows an axial section view of the exemplary collar of FIG. 1a with illustrative dimensions;

FIG. 3 shows an axial section view of an exemplary assembly comprising the collar of FIG. 1a;

FIG. 4 shows an axial section view through a bodymaker comprising the assembly of FIG. 2;

FIG. 5 illustrates and exemplary plot of detected force versus time; and

FIG. 6 shows a perspective view of an alternative exemplary force detecting collar for use with a can bodymaker.

### DETAILED DESCRIPTION

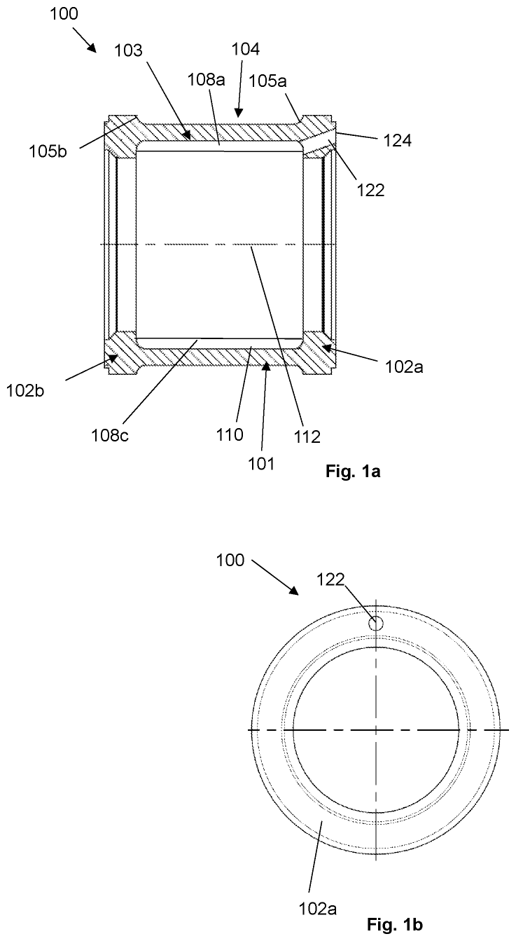

FIGS. 1a and 1b show respectively an axial section view and top view of a collar 100 for use with a bodymaker. The collar 100 is configured, in use, to be located around a nose portion of a ram of the bodymaker between a shoulder of the ram and an end face of a punch sleeve as will be described in more detail below, such that forces applied to the punch sleeve towards the shoulder of the ram are transferred via the collar. In particular, the collar may be configured to locate around an outer surface of the nose portion of the ram.

The collar 100 is generally cylindrical and comprises an elongate central cylindrical part 101 with enlarged end portions 102a, 102b at each end. The collar 100 is annular, and defines a central bore through which the nose portion is configured to extend. The end portions 102a, 102b extend radially inward and outward of the central cylindrical part 101 such that inner and outer circumferentially extending recesses 103, 104 extending completely around the collar 100 are defined. The end portions 102a, 102b further define respective circumferentially extending shoulders 105a, 105b which face one another across the elongate central cylindrical part 101. Load cells 108a-d are fixed around an inwardly facing surface 110 of the inner recess 103 of the collar 100. The collar 100 shown in FIGS. 1a, 1b comprises four load cells 108a-d (only two of which are visible in the Figures). The skilled person will appreciate of course that any number of load cells, even a single load cell, may be used. The load cells 108a-d each have a force detecting axis orientated parallel to the axis 112 of the collar 100.

In the illustrated example, the load cells 108a-d are equally spaced about the axis 112 of the collar, i.e. at angular spacings of 90 degree intervals. The skilled person will be able to envisage alternative arrangements, for example, a collar comprising separate recesses that accommodate individual load cells, or a collar comprising a different number of load cells with different spacing therebetween.

In the illustrated example, the outer circumferentially extending recess 104 has substantially the same location and axial extent as the inner circumferentially extending recess 103. The collar 100 may therefore comprise walls with a substantially I-shaped cross-section. The wall of the collar 100 to which the load cells 108a-d are fixed is therefore thinner than the end portions 102a, 102b. Having a thinner central region of the collar 100 tends to increase the extent of compression of the wall when axial forces are applied, increasing the sensitivity of the load cells which are fixed to that central region.

The collar 100 defines a channel or bore 122 providing communication between the inside and outside of the collar 100. More particularly, the channel 122 extends across one of the end portions 102a, inclined relative to the axis 112. The channel 122 accommodates one or more wires coupled to the load cells 108a-d for communicating electrical signals generated by the load cells 108a-d to external equipment (such as monitoring equipment). As will be described in more detail below, an exit opening of the channel 122 is aligned with an entry opening of a channel defined within a ram of the bodymaker to allow the wire or wires to be fed into an internal chamber within the ram. The collar is rotationally fixed (but importantly not axially fixed) relative to the ram of the bodymaker to maintain alignment between the exit opening of the channel 122 and the entry opening of the channel defined within the ram. For example, a spline or key arrangement may be provided between the collar 100 and the ram to prevent rotational movement of the collar 100 relative to the ram. This prevents the wire(s) extending through the channels from being damaged as a result of rotational movement of the collar 100.

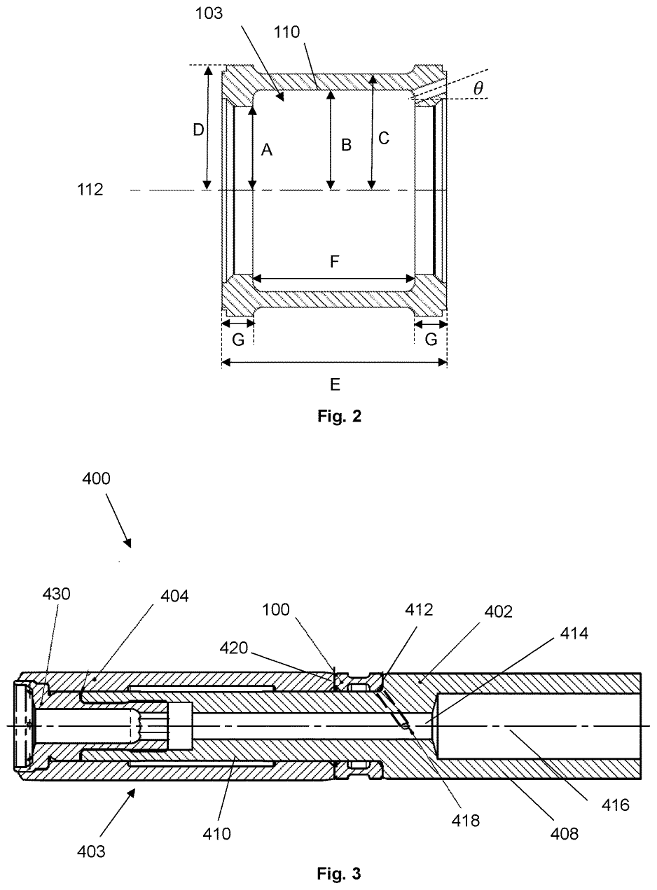

Considering the illustrated collar 100, this has the following principle dimensions as shown in FIG. 2:
A radius, A, of between substantially 18.6 mm and 19.2 mm, between the axis 112 and the radially innermost face of an end portion 102a, 102b.
A radius, B, of substantially 22.5 mm, between the axis 112 and the inwardly facing surface 110 of the inner recess 103.
A radius, C, of substantially 26 mm, as measured between the axis 112 and the outer recess 104.
A radius, D, of substantially 28 mm, between the axis 112 and the radially outermost face of an end portion 102a, 102b.
A length, E, of substantially 50 mm.
An axial length, F, between the axially inner faces of the end portions, of substantially 36 mm.
An axial length, G, of both end portions, of substantially 7 mm.
The channel 122 is inclined relative to axis 112 by an angle, θ, of substantially 20 degrees.

The dimensions A, B, C and D may be selected in dependence on the can size to be produced by the bodymaker that the collar 100 is to be used with. The dimensions of the collar 100 outlined above are for use with a bodymaker configured to produce a 33 cl, sleek beverage can. The skilled person will appreciate that alternative dimensions to those outlined above may be used for alternative collars configured for use with bodymakers designed to produce cans of different dimensions.

An alternative collar may be provided, with substantially the same features as those described above in respect of the collar 100, but with a different length, E, and a different axial length, F. For example, the alternative collar may have a length, E, of substantially 25 mm and an axial length, F, of substantially 11 mm. Further alternative collars may have a length, E, within a range of substantially 25 mm to substantially 50 mm. The skilled person will appreciate that in such further alternative collars the axial length, E, will be altered accordingly. The alternative collars may have the same dimensions A-D and G, and 0, as described above in respect of the collar 100.

The ratio of an axial length of the load cells 108a-d to the axial length to the length, E, of the collar 100 is 0.72 (or as a percentage, 72%). The axial length of the load cells 108a-d may be substantially the same as the axial length, F, of the collar 100. That is, the axial length of the load cells 108 a-d of collar 100 may be substantially 36 mm.

In the alternative collar described above, in which the length, E, is substantially 25 mm and the axial length, F, is substantially 11 mm, the axial length of the load cells may be substantially 11 mm. Again, in this alternative arrangement, the ratio of the axial length of the load cells to the axial length of the collar is 0.72 (or as a percentage, 72%). In further alternative arrangements, the ratio of the axial length of the load cells to the length of the collar may be 0.72 (or 72%) or greater, and the minimum collar length, E, may be substantially 25 mm. In further alternative arrangements, the ratio of the axial length of the load cells to the length of the collar may be 0.72 (or 72%) or greater, and the minimum collar length, E, may be substantially 20 mm. In further alternative arrangements, the ratio of the axial length of the load cells to the axial length of the collar may be at least 0.9(90 %) and the minimum collar length, E, may be substantially 20 mm. In further alternative arrangements, the ratio of the axial length of the load cells to the axial length of the collar may be 0.35 to 0.95 (or 35% to 95%) and the collar length, E, may be 25 mm to 50 mm.

FIG. 3 shows an assembly 400 comprising the collar 100 described above, a ram 402 and punch 403. The punch 403 comprises a punch sleeve 404 and a punch nose 430. The assembly 400 is for use with a bodymaker for forming metal can bodies as will be described further below.

The ram 402 comprises a generally cylindrical ram body 408 and a generally cylindrical nose portion 410 of smaller diameter than the ram body 408 such that a circumferentially extending shoulder 412 is defined at the junction between the ram body 408 and the nose portion 410. The ram 402 comprises an inner surface that defines an inner chamber 416 extending along the ram body 408 and the nose portion 410. Although not described further here, a primary purpose of the inner chamber 416 of the ram 402 is to provide a passage for compressed air to be pumped towards the end of the punch. The flow of air assists removal of the formed can body after they are drawn back from the domer and prior to entering the toolpack.

The ram 402 further defines a channel or bore 418 providing communication between the inner chamber 416 and the outside of the ram 402. An “entry” opening of the channel is aligned with the “exit” opening of the channel 122 of the collar 100 so that the one or more wires coupled to the load cells 108a-d are fed into the inner chamber 416. This arrangement avoids the need for wires to be routed through an external environment where oil and debris are likely to be present during use of the assembly 400.

The punch sleeve 404 is generally cylindrical and is coaxially located around the nose portion 410 of the ram 402. Specifically, the punch sleeve 404 locates around an outer surface of the nose portion 410 of the ram 402. The punch sleeve provides an end face 420 facing towards the right as viewed in FIG. 3. In use, the collar 100 is also located around the nose portion 410 of the ram 402, and specifically, the outer surface of the nose portion 410 of the ram 402, and disposed between the shoulder 412 of the ram 402 and the end face 420 of the punch sleeve 404. Crucially, whilst the collar 100 is supported by the nose portion of the ram 402, it is not axially fixed or clamped to the ram 402 other than by its abutment with the ram shoulder 412 and the end face 420 of the punch sleeve 404. Similarly, the punch sleeve 404 is not axially fixed to the ram nose other than by way of its abutment with the collar 100 and with the punch nose 430. As will be described in more detail below, this arrangement allows compression of the collar 100 between the end face 420 of the punch sleeve 404 and the shoulder 412 of the ram 402 during operation of the assembly 400. A combined gap of substantially 0.02 mm to substantially 0.051 mm is present between the end faces of the end portion 102a, 102b of the collar 100 and the punch sleeve 404 and ram shoulder 412. In alternative arrangements, a gap may not be present. However in such arrangements, as mentioned above, the collar is not axially fixed or clamped to the ram other than by its abutment with the ram shoulder and the end face of the punch sleeve.

The punch 403 further comprises the punch nose 430 fixed to a front end of the nose portion 410 of the ram 402 such that axial forces applied to the punch nose 430 towards the shoulder 412 of the ram 402 are transferred directly to the nose portion 410 of the ram 402. The punch nose 430 is received within the punch sleeve 404 such that, subject to some slight relative axial movement, the punch nose 430 and punch sleeve 404 together define and end profile suitable for forming, in combination with the dome, the can ends. The arrangement does however ensure that axial forces applied to the punch nose 430 are not transferred to the punch sleeve 104 and hence to the collar 100.

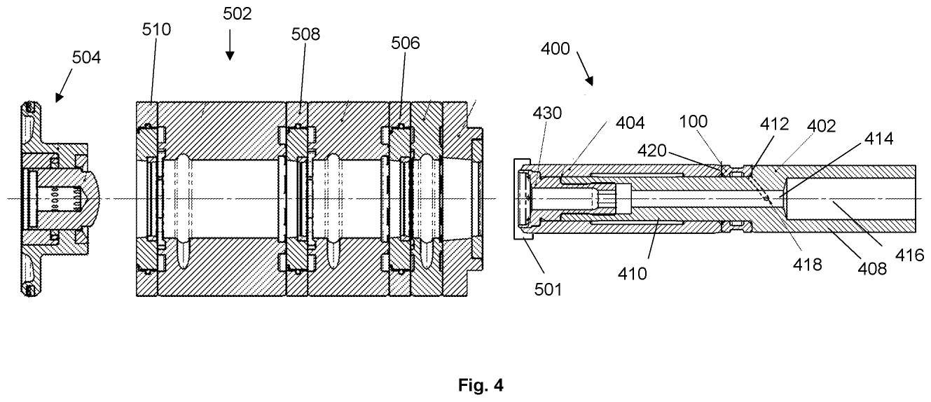

Use of the collar 100 with the assembly 400 is now described with reference to FIG. 4, which shows an axial section view through a part of a bodymaker comprising the assembly 400.

As already described, the collar 100 is installed around the nose portion 410 of the ram 402 between the shoulder 412 of the ram 402 and the end face 420 of the punch sleeve 404. Typically, in the conventional bodymaker, a spacer collar may be installed between the punch sleeve and the shoulder of the ram to the dimensions of the assembly 400 to be altered to suit the desired dimensions of the can bodies being formed by the bodymaker. Therefore, the collar 100 may be retrofitted to existing assemblies 400 in place of such a spacer collar thereby serving a dual purpose, i.e. force measurement tool and spacer. Of course, the collar 100 may be used in combination with one or more spacers located at one or both ends of the collar 100.

When the collar 100 is installed, the load cells 108a-d are located in a space between the collar 100 and the ram nose portion 410. The load cells 108a-d may be separated from the ram nose portion 410 by a seal. The seal may shield the load cells 108a-d from the harsh exterior conditions by preventing the ingress of debris and/or oil into the inner recess 103 within which the load cells 108a-d are accommodated. In the exemplary collar 100, the seal comprises a heat shrink film. However the skilled person will be able to envisage alternative seal arrangements.

The channel 122 through the collar 100 aligns with the channel 418 through the ram wall. The one or more wires of the load cells 108a-d are routed into the inner chamber 416 of the ram through the aligned channels into the inner chamber 416.

The one or more wires may be electrically connected to external equipment comprising one or more computing devices configured to display data deriving from the electrical signals generated by the load cells 108a-d. The connection between the one or more wires and the external equipment may be wired or wireless. In a wireless arrangement, a radio transmitter is located in the inner chamber 416 of the ram 402 and coupled to the one or more wires. The radio transmitter receives the generated electrical signals from the load cells 108a-d from the one or more wires and retransmits them over a radio interface to the external equipment. The external equipment may display the data derived from the electrical signals generated by the load cells 108a-d in real time.

Before undertaking the ironing process, a metal cup for forming into a can is prepared for the ironing process. This may typically involve cutting/punching a metal disk from a sheet of metal and drawing the disk into a cup. The cup may undergo a redraw process, as will be known in the art. The cup is then positioned on the assembly 400, and specifically the punch 403, to undergo the ironing process, in which the walls of the cup are stretched and thinned to achieve a can shape with walls of a desired thickness and length.

A cup 501 is shown positioned on the assembly 400 in FIG. 4. The base of the cup 501 abuts the front end of the punch nose 430 while the walls of the cup 501 extend along the outer surface of the punch sleeve 404. FIG. 4 also shows a bodymaker comprising a toolpack 502 and a domer 504. The toolpack 502 comprises a series of ironing die assemblies 506, 508, 510.

The assembly 400 drives the cup 501 axially towards and through the first die assembly 506. As the cup 501 is driven through the first die assembly 506, the walls of the cup are stretched and thinned as a result of the internal profile of the first die assembly being smaller than the external dimensions of the cup 501. As the cup 501 is driven through the first die assembly 506, forces are applied to the punch sleeve 404 axially towards the shoulder 412 of the ram 402 as a result of friction between the cup 501 and the first die assembly. Since the punch sleeve 404 and the collar 100 are not axially clamped to the ram 402, the axial forces applied to the punch sleeve 404 are transferred to the collar 100, and act to compress the collar 100 between the end face 420 of the punch sleeve 402 and the shoulder 412 of the ram 402. Therefore, the load cells 108a-d are compressed and generate an electrical signal indicative of the forces being applied to the collar 100.

The electrical signals are transmitted via the one or more wires to external equipment and provide an indication of the forces experienced by the ram 402 and or the assembly 400 during the ironing process. In alternative arrangements, the collar and/or assembly may comprise a transmitter configured to wirelessly transmit the electrical signals generated by the load cells 108a-d to the external equipment (for example, via Bluetooth or any other wireless communication protocol).

The electrical signals comprising force data may be used to determine whether the bodymaker is performing as expected. For example, the data may allow an operator to determine the point at which the punch or the die need to be replaced, and provide information on operation of the punch/ram during the ironing process that inform whether adjustments are needed to maintain quality and/or prevent tear off. Importantly, this information is provided in real time and allows operators to take corrective action before catastrophic failure. This ensures operational efficiency is maintained.

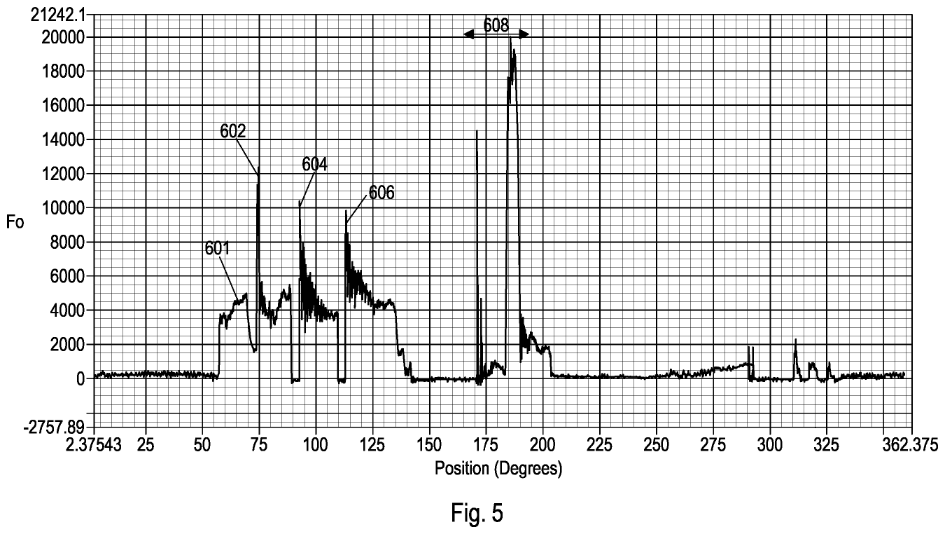

The process is repeated as the assembly 400 drives the cup 501 through the second and third die assemblies 508, 510 until a can body is formed, with walls of the desired thickness and length. Again, movement of the cup 501 and the assembly 400 through the second and third die assemblies 508, 510 causes compression of the load cells 108a-d of the collar 100 and generation of electrical signals indicative of the forces being applied to the collar 100 as the assembly 400 passes through the second and third die assemblies. FIG. 5 shows a typical output from the load cells 108a-d as the assembly undertakes the drawing and ironing process. The peak 601 may correspond to the point at which the assembly 400 is used to undertake the drawing process (i.e. the initial step in which the metal disk cut/punched from the sheet of metal is drawn into a cup, as described above). The peaks 602, 604, 606 respectively correspond to the points at which the assembly 400 passes through the first, second and third die assemblies 506, 508, 510.

Once the can body exits the tool pack 502, a doming operation is performed to form the bottom, domed, profile of the can body. The assembly 400 is driven axially towards the domer 504 such that the bottom of the can body engages the domer 504 to form a profile corresponding to the shape of the domer 504 in the bottom of the can body.

Once the can body exits the toolpack 502, the frictional forces experienced as the can 501 is pushed through the die assemblies 506, 508, 510 are no longer experienced and therefore no longer transferred to the punch sleeve 404. This is because the can 501 has completely passed through the die assemblies 506, 508, 510 and the external dimensions of the assembly 400, and specifically the punch sleeve 404, are smaller than the dimensions of the die assemblies 506, 508, 510. As such, significant forces are not experienced by the collar 100 between the point at which the can body exits the tool pack 502 and the point at which the doming operation begins.

The assembly 400 is moved axially towards the domer 504. During the doming operation, an axial force is transferred from the domer 504 to the punch sleeve 404 towards the shoulder 412 of the ram 402, and in turn to the collar 100. Similarly to the process described above, this causes compression of the load cells 108a-d causing generation of an electrical signal indicative of the forces being applied to the collar 100 during the doming operation. FIG. 5 shows a typical output from the load cells during the doming operation (see the output in region 608). NB. The load cells are electrically coupled together in parallel such that the illustrated force-time profile represents an average taken across the load cells. In alternative arrangements, separate profiles may be provided corresponding to the output of each, single load cell.

The punch nose 430 is fixed to the ram 402, but not the punch sleeve 404, and as such, the forces applied to the punch nose 430 axially towards the shoulder 412 of the ram 402 are transferred to the nose portion 410 of the ram 402, and not to the collar 100.

The above-described collar 100 allows the forces experienced by the punch and/or the ram during the ironing process and the doming operation to be directly measured. This is contrast to arrangements known in the art, in which sensing assemblies are installed on the toolpack/dies and used to provide an indirect method of measuring the forces experienced by the punch/ram. As such, the described embodiment allows for more accurate monitoring of the forces experienced by the punch/ram during an ironing process. The provision of more accurate data to the operators of the bodymaker allows the operators to more accurately identify the point at which the punch or the die may need to be replaced. Replacement of the punch or the die at the correct point reduces waste and increases operational efficiency by avoiding costly and time intensive machine/process failures as a result of punch and/or die wear. Further advantageously, the collar is able to be retrofitted to existing arrangements.

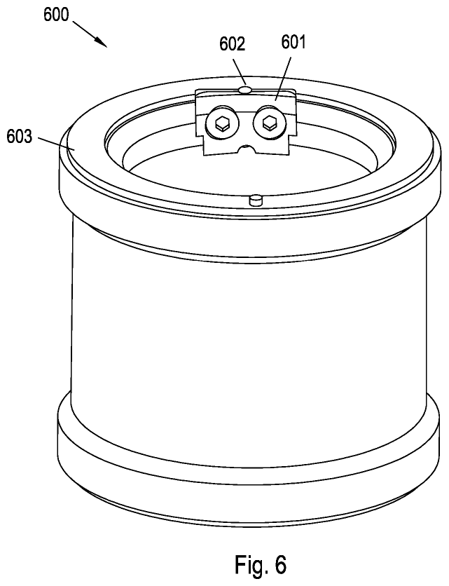

FIG. 6 is a perspective view of an alternative collar. Whilst the overall structure of the collar 600 is similar to that of the previously described collar, a clamp 601 is provided for attachment, e.g. by means of a pair of bolts, to an inner surface of one of the end portions 603 of the collar. The clamp sits within a correspondingly shaped recess provided on that inner surface such that the collar is substantially flush with the inner surface and does not interfere with axial movement of the collar relative to the ram on which it is located. Together, the clamp 601 and the inner surface of the collar define a channel 602 through which the wire or wires coupled to the load cell can extend. It will be appreciated that the channel extending from an interior to an exterior of the ram will be located so as to allow the wire to pass directly from the channel 602 through and into the ram. The clamp 601 can be tightened against the collar to secure the wire in place. This prevents “external” forces from pulling the wire relative to the load cells and thereby damaging the connections.

It will be appreciated by the person of skill in the art that various modifications may be made to the above described embodiments without departing from the scope of the invention.

1-19. (canceled)

20. A force detecting collar for use with a bodymaker for forming metal can bodies using an ironing process, the collar being configured to locate around a nose portion of a ram of the bodymaker, between a circumferentially extending shoulder of the ram and an end face of a punch sleeve, the collar comprising one or more load cells fixed to the collar and configured to generate electrical signals indicative of forces applied to the collar, between said shoulder of the ram and said end face of the punch sleeve, during operation of the ram.

21. A force detecting collar according to claim 20, wherein the one or more load cells are fixed to an inner surface of the collar.

22. A force detecting collar according to claim 20, further comprising first and second circumferentially extending end shoulders defining therebetween an inner circumferentially extending recess on an inner surface of the collar, the one or more load cells being fixed within the recess.

23. A force detecting collar according to claim 22, wherein the inner circumferentially extending recess extends completely around the inner surface.

24. A force detecting collar according to claim 22, further comprising a plurality of said load cells, the plurality of load cells being substantially equally spaced about the inner circumferentially extending recess.

25. A force detecting collar according to claim 22, wherein said circumferentially extending end shoulders of the collar further define therebetween an outer circumferentially extending recess on an outer surface of the collar.

26. A force detecting collar according to claim 20, the collar defining a channel extending between an inner surface and an outer surface of the collar and accommodating one or more wires coupled to the one or more load cells for communicating, in use, the generated electrical signals from the one or more load cells to external equipment.

27. A force detecting collar according to claim 26, wherein said channel is defined by a bore extending through the collar or by a clamping plate secured to an inner surface of the collar, the clamping plate configured to inhibit movement of said one or more wires relative to the one or more load cells.

28. A force detecting collar according to claim 20, wherein a length of the collar is approximately 25 mm to approximately 50 mm.

29. A force detecting collar according to claim 20, wherein a ratio of an axial length of the one or more load cells to a length of the collar is approximately 0.72.

30. A force detecting collar according to claim 20, wherein the collar is configured to locate around an outer surface of the nose portion of the ram.

31. An assembly for use with a bodymaker for forming metal can bodies using an ironing process, the assembly comprising:
a ram comprising a ram body and a nose portion and defining a circumferentially extending shoulder between the ram body and the nose portion;
a punch sleeve comprising an end face and being located coaxially around the nose portion such that said end face is opposed to said shoulder; and
a collar according to claim 20, the collar being located around the nose portion of the ram, between the circumferentially extending shoulder of the ram and the end face of the punch sleeve,
the assembly being configured such that forces applied to the punch sleeve axially towards said shoulder of the ram are transferred to said collar.

31. An assembly according to claim 31, wherein the collar is not axially fixed to the nose portion of the ram other than by way of abutment with the circumferentially extending shoulder of the ram and the end face of the punch sleeve.

33. An assembly according to claim 31, further comprising a punch nose fixed to a front end of the nose portion of the ram and at least partially received within the punch sleeve, the assembly being configured such that forces applied to the punch nose axially towards said shoulder of the ram are transferred to the nose portion of the ram and not to the punch sleeve.

34. An assembly according to claim 33, wherein the punch sleeve is not axially fixed to the nose portion of the ram other than by way of its abutment with the circumferentially extending shoulder of the ram and the punch nose.

34. An assembly according to claim 31, further comprising a collar according to claim 26, and wherein the ram comprises an inner surface defining an inner chamber, the ram further defining a channel extending between the inner chamber and an outer surface of the ram, the channel accommodating the one or more wires such that the one or more wires are received within the inner chamber.

35. An assembly according to claim 35, wherein opposed openings of the channels are aligned with one another.

37. An assembly according to claim 35, further comprising a radio transmitter located within the inner chamber, the radio transmitter coupled to the one or more wires for receiving said generated electrical signals and retransmitting them over a radio interface.

38. A can bodymaker for forming metal can bodies using an ironing process and comprising An assembly according to claim 31.
